(19) United States
(12) Patent Application Publication
(10) Pub. No.: US 2012/0295007 A1
(43) Pub. Date: Nov. 22, 2012

(54) PRODUCT AND METHOD FOR SIMULTANEOUSLY ENHANCING THE SENSORY APPEAL AND DIETARY VALUE OF CERTAIN FOODSTUFFS

(75) Inventor: Norman S. Singer, Highland Park, IL (US)

(73) Assignee: IDEAS Workshop, Inc., Highland Park, IL (US)

(21) Appl. No.: 13/454,069

(22) Filed: Apr. 23, 2012

Related U.S. Application Data
(63) Continuation-in-part of application No. 11/396,881, filed on Apr. 3, 2006, now abandoned.
(60) Provisional application No. 60/668,114, filed on Apr. 4, 2005.

(51) Int. Cl. A23L 1/308; A23L 2/52; A23G 3/42

(52) U.S. Cl. 426/590; 426/658; 426/660; 426/653

(57) ABSTRACT

A product and method by which a range of foodstuff products may be produced having a sufficiency of soluble dietary fiber to supplement dietary intake in a form that improves taste and texture. By adding a low viscosity, non-digestible fiber to foodstuff products in the form of a syrup composition, such foodstuff products have markedly enhanced sensory appeal and provide consumers a highly palatable source of dietary fiber.

### CROSS-REFERENCE TO RELATED APPLICATIONS

This Application relates to and claims priority as a continuation-in-part to U.S. application Ser. No. 11/396,881, filed Apr. 3, 2006, which claims the benefit of priority to U.S. Provisional Application Ser. No. 60/668,114, filed Apr. 4, 2005.

### FIELD OF THE INVENTION

The present invention relates generally to the field of food technology; more particularly, the present invention relates to methods of making food products having heightened amounts of dietary fiber.

### BACKGROUND OF THE INVENTION

The flavor characteristic of sweetness is one of the most pleasing taste experiences to humans. Sadly, we have found that this pleasure comes with many associated physiological maladies. For more than thirty years, the high simple sugar content of the North American diet has been recognized as creating or contributing to a variety of health challenges, including dental caries, diabetes, and obesity. Consequently, alternatives have been desired and sought. Alternative sweeteners have been subjected to scrutiny, including fructose, fruit syrups, less common sugars such as erythritol, isomaltitol, and trehalose, and high-intensity sweeteners. Each of the alternatives seem to offer certain health benefits. Unfortunately, the functional properties of these alternative sugars and sweeteners are so different from those of sucrose that, while significant progress has been made in providing product simulates, it has not been possible to faithfully replicate both the traditional flavor and textural characteristics in foodstuffs made with these alternative sweeteners.

During this same time period, the significance of dietary fiber has become well recognized, as has the generalized deficiency of dietary fiber in most Western dietary regimens. This deficiency is directly correlated with negative consequences for general health, including constipation, irritable bowel syndrome (IBS), diverticular disease, Crohn's Disease, ulcerative colitis, and gastrointestinal cancers. It is generally understood and accepted by medical practitioners in this field that gastrointestinal health is promoted by a moderately high rate of fecal transfer. This healthful rate of transfer is known to be greatly facilitated by ingestion of daily levels of dietary fiber that are significantly higher than exists in the typical Western diet. Soluble fiber is also recognized as being, generally, less irritating to the gastrointestinal lining than insoluble fiber.

While many consumable products based on dietary fiber have been introduced in recent years, they are characteristically lacking in attractive taste and palatability. Consequently, such products are less than pleasant to consume, making routine consumption of such products the exception rather than the rule. To say the least, the problem persists. For example, some dietary fiber supplements dissolve slowly and/or incompletely, so that the freshly-prepared slurry is gritty and unpleasant to ingest. If this preparation is allowed to stand, the grittiness decreases, but the viscosity increases, thus altering the experience to a different sort of unpleasantness. Other dietary fiber supplements produce very high viscosities when concentrated, such as occurs in the colon, thereby retarding the rate of fecal passage, and providing another obstacle to the desired objective of a moderately high fecal transfer rate. Still other such products are fermented in the colon, producing gas which is not only uncomfortable and frequently embarassing, but which can also drive urgency for bowel evacuation resulting in yet greater discomfort and inconvenience.

It is therefore an objective of this invention to provide a product and method by which a range of food products may be produced which are more pleasant in taste and texture than the conventional counterpart products, and which contain a sufficiency of soluble dietary fiber to effectively supplement the typically low fiber dietary intake, in a manner sufficiently pleasing that compliance with a prescribed regime is increased, thereby supporting the overall objective of promoting a healthy fecal transfer rate without gaseous effulgence.

Currently, the best-known dietary fiber supplement products available in the market include; psillium seed extract (e.g., METAMUCIL), methyl cellulose (e.g., CITRUCEL), and partially hydrolyzed guar gum (e.g., BENEFIBER). However, other entrants into this arena have also made their appearance in recent years. As an example, a little more than a decade ago, the Matsutani Company introduced a novel indigestible dextrin, described as “a low viscosity dietary fiber” (synonymously referred to herein as “LVDF”) derived from corn and marketed under the trademark FIBERSOL-2. [008]

The FIBERSOL-2 brand of dextrin is described in several patents assigned to Matsutani, including: U.S. Pat. Nos. 5,358,729, 5,364,652, 5,380,717, 5,410,035, 5,472,732, 5,519,011, 5,595,773, 5,629,036, 5,698,437, which are hereby incorporated by reference as describing an LVDF that is indigestible by humans and usefully employed in the context of the present invention.

FIBERSOL-2 is a soluble dietary fiber (90% min dry solids basis (“DSB”)) and is produced from cornstarch by pyrolysis and subsequent enzymatic treatment to purposefully convert a portion of the normal alpha-1,4 glucose linkages to random 1,2-, 1,3-, and 1,4-alpha or beta linkages. The human digestive system effectively digests only alpha 1,4-linkages; therefore the other linkages render the molecules resistant to digestion. Thus, FIBERSOL-2 is generally recognized as safe, i.e., has the same designation with the U.S. Food and Drug Administration as maltodextrin (pursuant to 21 CFR §170.30), is resistant to human digestion, and conforms to all working industrial and scientific definitions of dietary fiber. It is an off-white powder which is clear and transparent in 10% solution and resists both enzymatic and non-enzymatic browning. It is water soluble up to 70% (w/w) at 20° C. FIBERSOL-2 brand of maltodextrin has excellent dispersibility, very low hygroscopicity, and is stable in acid, heat/retort processing and freeze/thaw stable. It has very low viscosity of 15 cps in 30% solution at 20° C. Its sweetness is low, having less than a tenth the sweetness of sucrose at 30% total solids. Typical chemical properties of FIBERSOL 2 brand of maltodextrin include dietary fiber, 90% minimum DSB in accordance with AOAC method 2001.03, a moisture content of 5% maximum, no protein, no fat, DE between 8-12.5, pH 4.0-6.0 and 1.6 calories per gram (U.S.).

U.S. Pat. No. 5,472,732 (“the Ohkuma Patent) details the means by which Matsutani manufactures FIBERSOL-2 brand of LVDF; the Ohkuma Patent further describes the physical characteristics and impressive health benefits of FIBERSOL-2. Those descriptions are included herein by reference.

U.S. Pat. No. 5,458,892 (“the Yatka Patent”) describes use of FIBERSOL-2 in the making of chewing gum.

Beyond use for chewing gum, FIBERSOL-2 can be used in making many other foodstuffs, as contained in the following list copied from the Ohkuma Patent: black tea, cola drinks, orange juice, sports drinks, milk shakes, ice cream, fermented skimmed milk, hard yogurt, coffee whitener powder, candy, chewing gum, sweet chocolate (bar type), custard cream (panna-cotta type), orange jelly, strawberry jam, apple jam, bean jam, sweet jelly of beans, cereals, spaghetti, white bread, American donuts, wheat flower replacer, butter cookies, pound cake, sponge cake, apple pie, corn cream soup, retorted pouch curry, beef stew, non-oil dressing, dressing (MIRACLE WHIP type), mayonnaise, peanut butter, cheese powder, cream cheese, white sauce, meat sauce, beef and pork sausage, corned beef, hamburger steak, hamburger patty, liver paste, pizza, omelets, filling of meat pie, filling of Chinese dumpling, kamaboko, black berry liquor, dog food, cat food, pig feed, feed for broiler poultry, feed for laboratory rodent, and chewing gum.

The Yatka Patent and the Ohkuma Patent note that LVDF can be added to foods (as a means of adding dietary fiber) without jeopardy to the food. These patents neither teach nor claim novel functions of the novel LVDF food ingredient usefully employed in the manufacture of foods as set forth herein below.

We have discovered certain novel and advantageous uses of FIBERSOL-2 that have not heretofore been described, appreciated, or used. They are the subject of this patent application.

### BRIEF DESCRIPTION OF THE FIGURES

FIG. 1 is a table identifying the traditional stages observable in sugar syrup in the process of candy making

FIG. 2 is a graph showing the correlation of viscosity to temperature for gum Arabic, maltodextrin (DE10), FIBERSOL-2 and sucrose (reproduced from U.S. Pat. No. 5,358,729).

FIG. 3 is a graph showing the correlation between concentration and viscosity derived for FIBERSOL-2. It also marks the similarity of the viscosity of LVDF syrup to maple syrup.

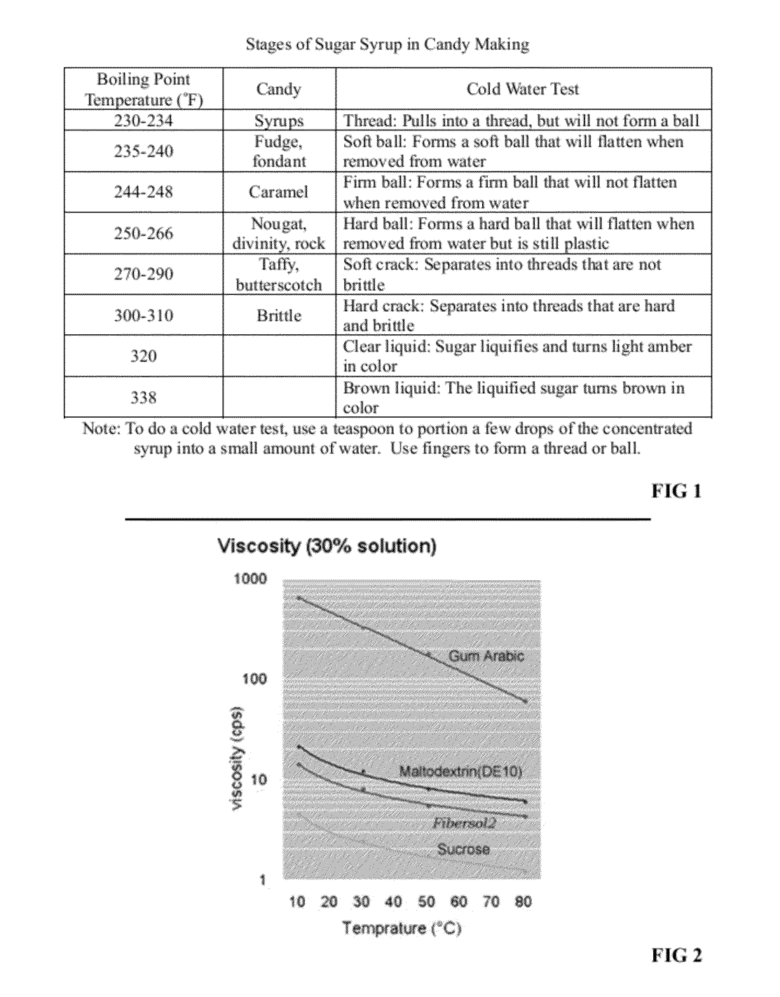

### BRIEF DESCRIPTION OF THE INVENTION

The present invention, in one embodiment, relates to the use of a dextrin-derived dietary fiber in a syrup for making a food selected from the group consisting of a hard candy, a toffee candy, a table syrup, a similate aged beverage, a confectionary glaze, coatings for fruits, a dried proteinaceous food, wherein the syrup comprises at least 60% dextrin derived dietary fiber.

In another embodiment, the present invention relates to a composition for the enhancement of food materials produced by hydrating an indigestible, low viscosity dextrin dietary fiber (60-70% solids content) under condition of sustained high shear during the dispersion and heating to obtain maximal disaggregation, yielding a clear syrup with a viscosity (at 25° C.) of about 35-300 cps, wherein the composition includes at least about 60% of the dextrin.

In yet another embodiment, the present invention relates to a composition wherein the indigestible, low viscosity non-digestible dietary fiber component is present in the composition in the range of up to about 96% by weight of the final composition.

The present invention in a further embodiment relates to a method for increasing the mellowness of a flavor, texture and or processability of foods and beverages, comprising the steps of incorporating the composition in said foods and beverages.

In another embodiment, the present invention relates to the use of the composition in producing dried proteinaceous foodstuff.

Yet another embodiment of the present invention involves the use of the composition in producing crisp coatings for dried fruits, dried vegetables, nuts or baked confections.

Another embodiment of the invention includes the use of the composition to enhance the aroma and taste of beverages, as in a beverage additive; or as a beverage additive enhancer when used at a level of about 0.5% to about 20% of the beverage to improve blendedness; or to confer mellowness to the flavor of an alcoholic, non-alcoholic, carbonated or non-carbonated beverage; or, with the inclusion of optional flavorants and when packaged for use by a consumer such that the consumer can improve the mellowness, blendedness and flavor of his alcoholic, non-alcoholic, carbonated or non-carbonated beverage, while at the same time, increasing its dietary fiber content.

In another embodiment of the invention, one can use the composition detailed above for preserving frozen foodstuffs, which use comprises the step of adding a low viscosity, non-digestible fiber component thereto intimately distributing fiber component of the composition there into, prior to freezing. This embodiment serves to protect the food from freeze-thaw damage, without requiring the sweetness contributed by the conventional agents, such as sugar, or sorbitol. In yet further embodiments for preserving frozen foodstuffs, a method usefully so employed further comprises the step of adding the composition described above to the foodstuff prior to freezing such that the content of low viscosity, non-digestible fiber to the foodstuff at (dry solids basis) is between about 10% to about 20% by weight.

Another embodiment of the present invention relates to an edible composition comprising, in combination, a low viscosity, non-digestible fiber and one of the foodstuff selected from the group consisting of beverages, yogurt, coffee whitener powder, candy, chewing gum, jelly, jam, cereals, pasta, donuts, cookies, cakes, pies, soup, meat stew, salad dressings, peanut butter, eggs, meat, and meat sausages.

Finally, in yet another embodiment of the present invention, one can use a composition for the enhancement of food materials produced by a food manufacturer by hydrating an indigestible, low viscosity dextrin under condition of sustained high shear during the dispersion and heating to obtain maximal disaggregation, in the course of preparing any of the foods or beverages herein described.

These and further embodiments of the present invention are further set forth in particular detail in the following section.

### DETAILED DESCRIPTION OF THE INVENTION

We have found that a syrup (prepared as described below) consisting of from about 20% to about 75% low viscosity dietary fiber (“LVDF”) and water has several remarkable, unexpected and unreported functions. In other embodiments, the range of LVDF is from about 30% to about 75%; or from about 40% to about 75%; or from about 50% to about 75%; or from about 60% to about 75%; or from about 60% to about 70%. Any suitable LVDF can be used, wherein suitability is determined by its substantially undigestable but soluble character such that it can serve as dietary fiber for a human or an animal. A suitable LVDF is generally derived from processing starch and, more particularly, in one embodiment, is a derivative of dextrin. One suitable LVDF is a dextrin derivative isolated from corn or potato or wheat, such as FIBERSOL-2, which is described in detail above. Other suitable LVDFs include alpha-cyclodextrin, maltodextrin, and nutriose (available from Roquette Freres, France). In one embodiment, the LVDF is FIBERSOL-2 or nutriose.

While the low viscosity dietary fiber (“LVDF”) herein described and used in the provided examples is FIBERSOL-2, this particular LVDF is used as just one example of a low viscosity dietary fiber. The embodiments presented herein of the present invention can be practiced using any starch derivative that may become available that has physical and biological properties substantially equivalent to those described in the Matsutani references (incorporated herein by reference) and which exhibits the characteristics and utilities as set forth and exemplified herein. Other such LVDF compounds include, for example, nutriose (Roquette Freres).

We have discovered that LVDF has a number of functions beyond being an indigestible soluble dietary fiber that are usefully employed in the manufacture of various foodstuffs. The new functions have heretofore not been reported. This small group of discoveries has provided a foundation for the development of the set of bellweather products described herein. The application of these discoveries, and the products they have made possible, are the subject of this patent application.

For example, we found that, when LVDF was prepared as a high solids syrup, as described below (hereinafter referred to synonymously as “LVDF syrup”) this LVDF syrup was found to demonstrate surprising new properties. As will be seen, the inventive syrup, prepared in the manner described below, displays a remarkable set of previously undescribed functional attributes that we have found are beneficial to the sensory appeal of certain food and beverage products.

The simplest new utility we found is that the syrup so produced is, itself, characterized by surprisingly pleasant sensory qualities, and thus is usefully employed without adding more. That is, we found that when a LVDF syrup is prepared (65 to 70% solids content, as described below), it has a pouring character and mouthfeel that are remarkably similar to those of a high quality maple syrup. The measure of “mouthfeel” is one commonly appreciated by those skilled in the tasting art, and is the result of the product's physical and chemical interaction in the mouth.

For assessing the usefulness of the LVDF syrup itself, we take a high quality maple syrup to be the premier table syrup in North America (as indicated by price and consumption data). The low intrinsic flavor, added to the pleasant mouthfeel of the LVDF syrup encouraged us to explore subsequent product developments. We came to understand that a variety of other flavors can readily be carried in this novel, neutral-tasting syrup, providing hitherto unimagined products. The commonly-available carbohydrate syrups are of limited advantage in the production of a maple syrup simulate in that they have either the full 4 calories/gram, and/or limited solubility and/or very high viscosities at solids contents high enough to afford microbial protection. Further, those that do provide dietary fiber content are to some extent fermentable, producing large volumes of gas in the large intestine, while the colligative properties of the unfermented residue induces diarrhea.

When the long list of foods listed in the cited Matsutani patents is reviewed, no “table syrup” product can be found. While the word ‘syrup’ (made from LVDF) is frequently mentioned in the Yatka patent, it is mentioned exclusively as an intermediate in various processes for making chewing gum; but never as a table syrup per se or as the base for a table syrup.

More specifically, none of the aforementioned Matsutani patents disclose or suggest the use of the LVDF syrup for a table syrup. Such products have been prepared and disclosed in this patent application, using the inventive syrup with small quantities of flavorant, colorant and sweetener.

We have also found that the inventive LVDF syrup functions as a novel ‘Candy Doctor’ (defined below) in the making of hard candies, that is, even as the sole means of preventing the crystallization of sucrose ‘glass’ and in combination with conventional Candy Doctors. “A glass” is any of various amorphous materials formed from a melt by cooling to rigidity without crystallization.).

We then found that an LVDF-doctored hard candy could be used to create a novel, and very pleasing new product by using it to enrobe dry fruits, nuts or baked confectionary pieces and then drying the coating.

We further found that the inventive LVDF syrup confers upon conventional foods into which it is incorporated, a more pleasing mouth-feel. The mouthfeel, as alluded to earlier, includes both the consistency and mouthfeeling factors—such as smoothness/roughness, slipperiness/stickiness, etc.—of fluid foods and the crunchy/mealy textures and mouth feeling factors of dry, solid matrices produced by frying, drying, baking and the like.

We also found that when LVDF syrup is added to a beverage at a level of 2% to 20%, it confers upon that beverage the highly desirable qualities of smoothness and mellowness (meaning, well-blendedness of flavors) normally found only in well-aged beverages.

We were also surprised to find that when LVDF (especially as the syrup) is intimately distributed throughout a protein matrix which is vulnerable to freezing, or intended to be frozen, it protects that matrix from the textural damage that would otherwise occur upon freezing and thawing.

That this was observed with the LVDF syrup was surprising because by whatever means the LVDF protected the food from freezer damage, it could not have been the lowering of the freezing point of the water contained in the food. It could not have produced that effect because it is a colloidal sol, not a solution, so it can not have any of the colligative properties normally associated with added sugars or salts. While not limiting on the invention, and irrespective whatever is the physic-chemical basis for the protection observed and caused by combining the LVDF syrup with a protein matrix, the inventor believes that the effect by which LVDF syrup protects the food is by providing interference with the growth of ice crystals, rather like the pieces of paper between the slices of cheese that would otherwise stick together, sometimes tenaciously, It is well accepted in the food field that the textural damage often seen in foods that have been frozen, is produced by the cellular (or other stricture) disruption produced by the ice crystals growing through the cell walls (or other desirable structures), producing the same sort of change as bursting a balloon. Since the surface of ice crystals is hydrophobic, it is possible that some of the hydrophobic sections of the LVDF molecule could bond to those ice crystal surfaces, thereby interrupting, or at least retarding, further ice crystal growth.

We found that it was possible to prepare a syrup consisting of about 20% to about 75% LVDF solids and water, and that this syrup has good shelf stability, as well as a fluid character and organoleptic qualities virtually identical to a high quality maple syrup. Other embodiments, as noted above, have varying brackets of LVDF solids percentages that can be usefully employed. The flavor of these syrups was so mild that by means of the facile addition of an intense sweetener and appropriate, available commercial flavorant and colorant the bland syrup was easily converted into a very convincing simulate of maple syrup. This same bland base syrup can be used to ‘carry’ a wide variety of flavors.

### Example 1

### High Fiber, High Solids Syrup (“LVDF Syrup”)

LVDF (FIBERSOL, Matsutani, 65 parts by weight) was dispersed under shearing forces (3″ diameter turbine blade at about 1-2,000 rpm) in (distilled) water (35 parts by weight), sheared to disperse, and during heating (HAAKE constant temperature bath) to 60° C., and held, with reduced shearing agitation at this temperature until it cleared. It was then packaged and allowed to cool. A significant decrease in viscosity was seen as the turbidity disappeared. It was then ready for use as described herein. It should be noted that this heating could also function as a pasteurization or sterilization.

The composition was prepared in accordance with Table 1, below, with all percentages given as weight percentages.

TABLE 1

| Ingredient | Supplier | Wt. % |
|---|---|---|
| LVDF | Matsutani | 65.0 |
| Water | | 35.0 |
| Total | | 100.0 |

When this LVDF syrup was prepared as above, but with only mild agitation, it was seen to behave less desirably in coating dried fruits or nuts (a thicker coating, and a greater tendency for the individual pieces to stick-together during cooling). See below.

### Example 2

### High Fiber Maple-Flavored Syrup

The base syrup described in Table 1 above, was modified by the addition of appropriate levels of suitable flavorant and sweetener as shown in TABLE 2.

TABLE 2

| Ingredient | Supplier | Wt. % |
|---|---|---|
| LVDF | Matsutani | 65.0 |
| Water | n/a | 33.7 |
| Aspartame | NutraSweet | 0.3 |
| Maple Flavor | McCormick | 1.0 |
| Total | | 100.0 |

A serving of this LVDF Maple Syrup simulate (two tablespoons) has the nutritional profile, in comparison with real maple syrup shown in Table 3 below:

TABLE 3

| | Carbohydrates | | Fiber |
|---|---|---|---|
| Product | (g) | Calories | (g) |
| Vermont Maple Syrup | 19.5 | 78 | 0 |
| Product of Ex. 2 | 4.1 | 16.4 | 15.0 |

The nutritional advantages of lower carbohydrate, lower calories and higher fiber content are evident.

The fact that a syrup containing no sugar as we report, is easily pourable, and has sensory characteristics of maple syrup is quite unexpected.

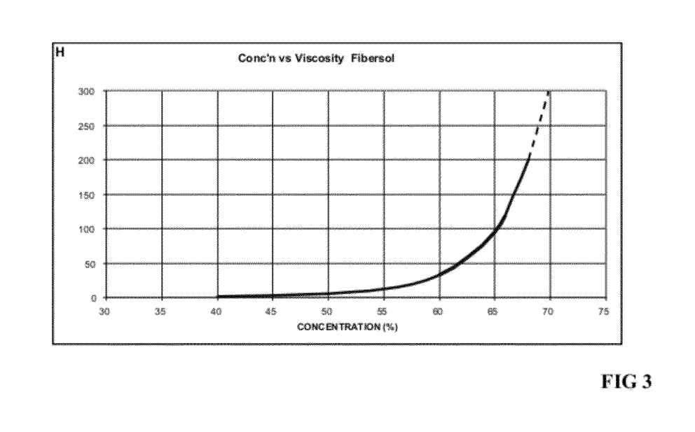

FIG. 3 represents the viscosity data we obtained from conducting a viscosity assay of the Matsutani Fibersol 2, when prepared as described and cooled to about 20° C.

As graph #3 shows, the viscosity of Fibersol is, in fact, very low, at concentrations below about 55%, but thereafter rises sharply. However, we have found that, while this curve does indeed rise sharply, the solutions remain fluid, and in fact, a 65% syrup, at room temperature, has a pouring character that is virtually identical to that of high quality Maple Syrup. For reference, points “1” and “2” on the graph indicate the viscosities of two commercial brands of Maple Syrup. Thus, this portion of the curve is in fact a region of great practical utility.

### Candy ‘Doctor’, Background

It has long been known that when a sucrose solution is boiled, water evaoprates therefrom, and thus, its solids content increases, and consequently, the temperature at which it boils also increases. Further, as the solids content increases, the physical character of the product obtained by cooling at that temperature also changes in predictable ways. Standard curves are available in the industry relating temperature of boiling to solids content of the boiling syrup, and the character of the product obtained if cooled at that temperature. It is generally taken that at a temperature of about 300° F., the moisture content is below about 2%. At this level of dryness, the syrup, when cooled will form a crisp glass known as “hard candy.” However, it will shortly thereafter spontaneously degrade to a mass of “sandy” granules. That is, the glass will crystallize. Long ago it was found that this product disaster can be averted by the replacement in the original syrup of about 20% to about 30% of the sucrose by “invert sugar,” i.e., sucrose that has been hydrolyzed to its component simple sugars, glucose and fructose. Later, corn syrup was found to be more convenient. The invert sugar or corn syrup were called “Candy Doctors” in that they ‘cured’ the crystallization. The use of corn syrup has, since that early time, been standard practice in the candy industry. The ‘penalty’ of this standard practice is that the product develops a certain heaviness of mouthfeel and stickiness, especially to the teeth, which are factors to which the industry has become accommodated.

When we used LVDF syrup to completely replace the usual ‘candy doctors’ such as invert sugar or corn syrup in the making of hard candies, we were surprised to find that the hard candies so produced not only did not crystallize, they were, in several ways, superior to conventional hard candy products. Moreover, adding to the initial surprise, the LVDF syrup produces a hard candy with a more appealing mouth-feel and flavor than is obtained with the conventional ‘doctors.’ One of the attractive features of the use of LVDF syrup as a candy doctor is that the resulting hard candy is virtually free of the stick-to-the-teeth character found in conventionally doctored hard candies. As well, in the absence of stickiness, the LVDF-doctored hard candy is unprecedentedly smooth to the tongue and palate: a surprisingly pleasant and entirely novel sensation.

While the related family of ‘malto-dextrins’ can also function to some extent as candy doctors, they tend to add excessive viscosity to the candy melt (making it difficult to handle) and an unpleasant ‘heavy’ (gummy) mouthfeel. As well, they contribute no fiber but do contribute a full 4 calories per gram to the consumer's metabolism.

It should be noted that, while Matsutani's U.S. Pat. No. 5,364,652 does mention the use of their LVDF in the manufacture of a “candy,” it does not teach that its LVDF (which is the dextrin derivative Fibersol) is usefully included for anything apart from replacing some sucrose and/or adding dietary fiber; the '652 patent neither discloses nor suggests the use of LVDF as a candy doctor. Matsutani persists in the conventional practice of including corn syrup—the most common candy doctor—in its preparation. As well, the resulting mixture was cooked only to “Bx 80” (“Bx” stands for “Brix”, a measure of total solids in solution) before cooling. Thus, the candy still contained 20% moisture, and, would therefore have had the character of a fudge or caramel rather than a hard candy, which has a typical moisture content in the range of 0% to 3%. This higher moisture candy would be at far lower risk of spontaneous crystallization.

### Example 3

### A High-Fiber Candy Doctor

The ability of LVDF (FIBERSOL 2, Matsutani) to serve as the sole ‘doctor’ in the preparation of an otherwise conventional sucrose hard candy is demonstrated by the following:

TABLE 4

| Ingredient | Wt. % |
|---|---|
| Sucrose | 68.75 |
| LVDF (Matsutani) in syrup form | 28.00 |
| *Water | 2.0 |
| *Aspartame (NutraSweet) | 0.25 |
| *Strawberry Flavor (McCormick) | 1.0 |
| TOTAL | 100.0 |

*Added after cooling to about 150° C.

These proportions were calculated as final composition, based upon initial weights of ingredients used in syrup preparation and final weight.

The sugar and LVDF syrup in Table 4 were dissolved in the water and brought to a boil with constant stirring, i.e., brought to a temperature of from about 160° C. to about 170° C., at which point the heat was lowered and the vessel was covered, and held in this condition for 5 minutes to ‘wash down the sides of the vessel with condensate’ (as is common practice in cooking hard candies) and so assure the absence of dried crystals on the sidewalls (undesirable as they could ‘seed’ crystallization of the sugar and thus prevent the formation of a glass). The vessel was uncovered, the heat returned to moderately high, and boiling was continued, with occasional stirring (to avoid sticking to the bottom) to the point of dryness (about 98% solids). After cooling to about 150° C., the aspartame and flavor were added, after which the flavored candy melt was immediately used, as in Example 4, below.

Further Observations Relating to Candy Uses:

I also observed that, as this candy cook proceeded, the cooked syrup seemed to arrive at the desired character for making hard candy (Hard Ball Test), at a surprisingly lower temperature (ca. 250° F., at which temperature, one could make caramels).

When I repeated this protocol, at a later date, I added the precaution of weighing the syrup as each temperature was recorded. This confirmed that when a sugar syrup, containing LVDF syrup is cooked in the usual manner, it arrives at ‘dryness’ about 50 degrees lower (i.e., sooner) than when cooked with conventional candy doctors.

The reason for this phenomenon is dramatically explained by the following experiment.

A liter of LVDF syrup (with nothing else added) was cooked in the usual manner of cooking syrup to make candy, (except, as in the earlier test, I used a teflon coated Wok that has a tight fitting lid)

The level of syrup in the pot dropped steadily, until I stopped it because the level (now about 100 cc) was too shallow to permit a reliable measurement of temperature. The surprising observation is that the temperature at no time during this 20 minute cook ever rose above the boiling point of water.

Dry crusts of LVDF could be seen on the surface of the always boiling fluid, and they covered the walls of the pan as the fluid level dropped. That is, the LVDF dropped out of its sol state as its concentration exceeded its maximum at those conditions.

In other words, LVDF syrup is a truly non-colligative material that can provide important process-advantages to the food processor, and that is characterized by properties that will make it also attractive to the consumer.

Therefore, when I used LVDF Syrup as a candy doctor, it contributed solids content, but had no impact on the boiling point. When the temperature of that cooked syrup was found to be about 250° F. which would normally mean it had solids content of about 90% to 92%, it in fact had a solids content of 98%, which is normally reached at a boiling temperature of about 300° F. to about 310° F.—the usual temperature for preparing hard candies.

Please note that, as water is driven out of the system of Sugar/Water, it takes progressively more energy to drive more water out. The time for candy cooking syrup to 250° F. is equal to or less than the time (energy) required to proceed from 250° to 300° F. It should also be noted that at about 300° F., the sugar is perilously close to its degradation temperature: nobody wants candy that is burned black.

The consequences of this include:

1. Lower energy costs (few companies now make hard candies because of the high energy usage it requires)

2. More productivity from existing equipment, resulting in further savings

3. A safer, easier cook because it ends 50 degrees F. below the degradation temperature.

4. Simplification of process, in that flavors that would have boiled off at the higher temperatures can now be added to the cooked syrup directly in the cooker, eliminating a process step and attendant yield loss.

Therefore, as a processing aid alone, this will be a boon to the candy industry.

### Example 4

### High Fiber Hard Candy

The mixture was quickly filled into 1″ diameter, half-round molds, that had previously been lightly sprayed with an edible mold release agent. When cooled, the bright glass-clear candies easily de-molded. When placed in the mouth, they were glass-smooth, slow to dissolve, pleasantly sweet, with an attractive strawberry flavor (of course, any of a wide variety of other flavorings could be used). When the candy had completely dissolved, it left no aftertaste, and no residual mouth feelings. This phenomenon is very desirable, and is known as a “clean aftertaste.” Each such candy weighed about 7 grams, of which about 2 g were soluble dietary fiber. Therefore, the consumption of about 6 such candies would provide about 12 g dietary fiber, an amount that would, on average, bring the average US consumer's dietary fiber intake up to the level recommended for good intestinal health.

When held in a closed jar for several months at ambient conditions, these LVDF-doctored hard candies did not crystallize.

### Example 5

### High Fiber Hard Candy Glaze

In a manner similar to conventional practice in traditional hard candy production we found that the candy described in Example 4 above can also be used as a glaze.

We dipped a piece of dried fruit (held in a fondue fork) into a bath of cooked hard candy syrup (as described in Example 4) and then allowed the coating to cool until it hardened. This simple process was seen to have transformed the dry, pale, friable dried fruit structure into a glossy, brightly-colored confection that had a crisp to crunchy texture, a more pronounced strawberry flavor and an improved sugar/acid ratio (i.e., a more balanced flavor). In short, an interesting piece of food had been transformed into an exciting new confection. So far as we have been able to ascertain, this is a truly novel product.

Process Details

The composition shown in Table 4 was cooked to a boiling temperature of about 160-170° C. then cooled to, and held at, about 150° C. (in a HAAKE constant temperature bath). Freeze-dried strawberries, (each held on a fondue fork that had been modified by removing the barb) were dipped into this hot syrup. Upon removal from the syrup a small spatula was used to assure that all portions of the surface of the berry had been covered. Immediately after coating, the coated fruit was lightly sprayed with a lecithinated oil and rotated under a stream of air hot enough, and for a sufficient time to ‘anneal’ the coating (as indicated by a uniform glossy appearance). The coated berries were then allowed to cool while still mounted on the forks which were held in a wooden block drilled with a row of holes, for this purpose. When cooled to 25° C., the coated fruit was seen to be bright, glossy (fresh-looking) and to have a pleasing crisp, crunchy clean texture, and a distinctly improved taste as compared to the uncoated dry fruit. By “distinctly improved taste” we refer to a more intense strawberry aroma, a more balanced sugar-acid ratio, and a crisp clean texture and clean mouthfeel rather than the dry-foam texture and powdery, drying mouth-feel of the original freeze dried fruit.

The syrup blend had not been cooked to dryness since it would be spread in a thin layer, and exposed to a stream of hot air which was found sufficient to complete the syrup-drying.

Further, the coated fruit pieces demonstrated vastly superior resistance to breakage and crushing. Further still, unlike un-coated fruit which is well-known to be highly hygroscopic, the coated fruit was not.

Another surprising aspect of this work is the finding that, while it is made without any added fat, it was found to have the sort of “short” texture one would normally only get with a fatty candy (e.g., peanut brittle, praline). Therefore, this new form of hard candy holds considerable promise in the preparation of products with high sensory qualities, and low fat levels.

### Example 6

### Non-Fat Banana Chips

The hard candy glaze and glazing method of Example 5 was used to coat Freeze Dried Banana Slices. When cooled, these chips had a pleasant somewhat glossy appearance, a rich banana flavor and a crisp clean texture very similar to conventional “Banana Chips.” However, conventional “Banana Chips” are prepared by frying slices of plantain (a starchy relative of banana). These fried chips therefore carry a burden of about 20% to 35% fat. In contradistinction, the product of Ex. No. 4 is fat free, yet seemed as pleasing to the palate as the full-fat conventional product.

Of course, many other fruits can also be transformed in this way, including other dried (preferably freeze-dried) berries, cherries, freeze-dried balls cut from apple, melon, papaya, mango, etc. or freeze-dried slices of banana. These non-berry fruits can also be cut into shapes such as slices, cubes, julienne or flakes, (before drying and coating) in which forms they would also be especially attractive as garnishes for cake-decorating and food service. As well, while we have referred exclusively to “freeze-dried” fruits, we mean to include any means of drying that produces similarly acceptable textural effects.

Using the product of Example 5, a glaze was prepared with the same ratio of dietary fiber to sugar as is found in the fruit itself: i.e. 30%. Thus, regardless of the weight of glaze added to the strawberries, the final ‘Proximate Composition’ of the product remains “Fiber, 30% of total carbohydrates.” This claim has not heretofore been possible.

Of course, a similar product can also be prepared using a conventional hard candy formula, but while it is also novel, and has the improved appearance, much of the improved texture and flavor, it lacks the improved mouth feel, the reduced hygroscopicity and the reduced cariogenicity. Perhaps more importantly, it lacks the contribution of dietary fiber, as well as the reduced caloric content. Nonetheless, it will likely be found to be of interest in certain market segments.

### Example 7

### High Fiber Glazed Dry Fruits, etc

TABLE 4

| | SOLIDS | WEIGHT |
|---|---|---|
| COMPONENT | (weight %) | (parts by weight) |
| syrup of Example 1 | 65 | 30 |
| sugar (sucrose) syrup | 65 | 70 |

TABLE 5

| | WEIGHT |
|---|---|
| COMPONENT | (per 100 berries) |
| Freeze Dried Berries | 150 |
| Coated berries | 450 |

The amount of glaze that was picked-up by the dry berry in this manual, prototype process was somewhat heavier than anticipated. We believe that a properly-configured production process can be designed to allow for controlling the weight of the glaze applied. On the other hand, since the glaze consists of a substantial amount of dietary fiber, and since the product described was very well received by all tasters, we believe that even as shown, the product would achieve the overall dietary objective.

### Example 8

### High Fiber Glazed Nuts

Peanuts were added to the hard candy glaze of Example 5 at a temperature of about 180° C. manually stirred in a 5 gallon vessel until the temperature of the mix rebounded and reached about 190° C. The heat was immediately turned off and about 2% of lecithinated oil was poured over the tumbling mass to aid in separating the nuts before the coating cooled. When acceptably separated, the coated nuts were poured onto a cooling table, under a battery of fans. The nuts were stirred and further encouraged to separate by (gloved) hands. Once the nuts were adequately separated, they were allowed to cool to about 25° C.

The high-gloss smooth fiber glaze on the nuts made them looked like gems, especially the pistachios. They were smooth and clean-handling, with a pleasing crunch and a full favor, characteristic of the nut that had been coated.

Since the products we had encountered to this point were all characterized by an improved flavor and texture, as compared to the conventional product, we decided to see how far afield that effect might extend. Consequently, we added various levels of LVDF syrup to a variety of conventional foods and beverages, and carefully tasted the results.

### Example 9

### Flavor Mellowing

We evaluated the effects produced by adding the inventive syrup to a variety of beverages and confections. We were surprised to find that, when added even at low levels (0.5 to 10%) to any of these products, the thus-amended products tended to show the same qualitative improvements. Namely, the flavors in the LVDF-amended products displayed a mellower flavor, with a more well-blended, smoother taste and aroma than the original product. This kind of qualitative enhancement is very highly prized. It is conventionally found, for example in the more costly teas, and the finer wines and chocolates. This novel finding, therefore, has great economic potential.

While we expect that many (if not most) producers will prefer to use the syrup form, however, we suspect that some manufacturers will be set up to add dry ingredients in a blending line, and will have suitably intense mixers to provide the necessary dissolution, so long as that condition is met, then we submit that this will fall under the definition of this invention. We anticipate that in those instances where a product is offered for general use by a consumer so that he can enhance foods or beverages to his taste, that the consumer will prefer to add the enhancer as a syrup, as this form would be more convenient.

### Example 10

### Non-Sweet Cryoprotection

We found that when LVDF syrup is intimately distributed throughout a protein matrix which is vulnerable to freezing, such as egg yolk, or surimi (fish paste), such matrix is protected from the typical textural damages inflicted upon these fragile food materials by the freezing-thawing process.

This freezer damage is believed to be produced by the nature of ice. It is in the nature of ice crystals that the larger ones grow at the expense of the smaller. As the ice crystals grow, they pierce cell walls, macerate tissues, and emulsions. Over time, the ice crystals will meet and fuse forming ‘plates’ that compress the non-aqueous components of the tissues (or the matrix) which become compressed ever more tightly between the advancing ice “plates.” Forces on the order of tons/sq.in. have been reported. When such tissue is allowed to defrost, the ice plates melt, forming zones of almost pure water amongst the debris that previously had been the organized structure of the tissue or matrix. When such food material is eaten, it is experienced as having been significantly changed in texture: almost always for the worse. The exact nature of this textural change will depend upon the food material in question. It will be either tough and watery or simply ‘mushy’.

As an example, it is well-known that egg yolk becomes gelatinous when frozen without protection. This gelation has been reported to be the result of a coalescence of the egg lipids which is forced by the advancing ice plates. It is also well-known that Surimi (that is, mechanically de-boned fish flesh in pâté form) and surimi-derived products become coarse-textured when frozen without suitable protection. Conventionally, such protection is conferred upon such fragile foods by sucrose, glucose, corn syrup or sorbitol. These agents, unfortunately, in each case, add sweetness proportional to their concentration in the food. Sweetness in such foods as eggyolk and surimi is out-of-place, un-natural, and therefore less than appealing. This sweetness has limited the breadth of usefulness of this approach. Consequently, manufacturers of such products have, of necessity, constrained their use of these conventional protective agents and accepted the reduced market penetration arising from this taste fault.

Therefore, we explored the possibility of using LVDF syrup in lieu of sugars or sugar alcohols to accomplish this ‘cryoprotection’. We reasoned that the amount of water that would be added would not be as important as the non-sweet cryo-protection obtained.

LVDF syrup was blended into freshly-separated, well-mixed egg yolks, at levels ranging from 0.1 to 20% (dry solids basis). The prepared samples were frozen, held frozen for 2 days, defrosted at room temperature and examined. A sample of un-treated yolk was used as a reference control, and a sample into which 20% sucrose (in the form of a 50% syrup) had been blended (as experimental control) were also frozen and defrosted in the same way. We found that gelation was prevented by the incorporation of 20%, 15% and 10% LVDF. While the apparent viscosity of the LVDF-yolk was higher than that for the sugar-yolk, the LVDF-yolk was still fluid enough to be pumpable. This was determined by means of the following analog method.

A thin spatula was drawn through the defrosted yolk, making a deep groove. In all of the LVDF-amended yolks the walls of this groove immediately sagged, flowing inwards and downwards. Whereas, when the same was done to the reference control, the walls of the groove remained in place. This indicates that the yolk frozen with 10% (and greater) LVDF (in syrup form) was significantly protected from freezing damage by the presence of the LVDF.

Thus, LVDF (preferably as the syrup) offers the unique opportunity to protect such foods from freezing-damage, without burdening the food with sweetness. This has not heretofore been possible.

This same protection may be afforded to other food materials as well, including: surimi (i.e., mechanically de-boned raw fish meat pâtê), lunch meats, pâtês, soups, sauces or fruits.

We have now shown that LVDF syrup can replace sugars and sugar alcohols as the means to preserve textural integrity through the freezing process.

We have seen that low viscosity in our preparation of LVDF syrup correlates with best performance in each mode of benefication.

We believe (however this is not meant to be limiting) that both the lower viscosity and the improved performance arise from a more complete disaggregation of the dextrin which is accomplished by the sustained high-shear imposed during dispersion and dissolution.

### Example 11

Set forth with respect to Examples 143-144 of the Yatka Patent at Column 22, Yatka stated “Fibersol 2 was used to prepare a 78% solids syrup solution by mixing 2994 grams of Fibersol 2 with 844 grams of near boiling water using a mechanical stirrer.” In attempting to repeat Yatka's recipe for generating a 78% solids syrup solution, it can be seen that two different approaches may be indicated by Yatka's words: Either one brings the water near boiling and then adds the (room temperature) Fibersol-2, meaning the water plus Fibersol-2 will be significantly lower than boiling almost immediately, or the container including the near boiling water remains on a hot plate that has mechanical stirring capability as well, so the temperature of the water will remain closer to near boiling. Either way, a fully dissolved solution could not be attained using Yatka's described protocol, even when adding additional heat that is not even recited by Yatka. At best, when one prepares such a 78% Fibersol-2 “syrup” in accordance with Yatka, the result is a slurry that includes undissolved clumps of Fibersol-2 in formations referred to in the industry as “fish-eyes.”

While it will be understood by those of ordinary skill in the art, that the foregoing embodiments are described with reference to their preferred embodiments, it will be understood that the Examples provided are intended merely to illustrate particular formulations and uses of the present invention, and are not limiting of the present invention, which is limited only by the scope of the claims appended hereto.

What is claimed:

1. Use of a dextrin-derived dietary fiber in a syrup for making a food selected from the group consisting of a hard candy, a toffee candy, a table syrup, a similate aged beverage, a confectionary glaze, coatings for fruits, a dried proteinaceous food, wherein the syrup comprises at least 60% dextrin-derived dietary fiber.

2. The use of a dextrin-derived dietary fiber of claim 1, wherein the syrup has a viscosity of about 35 cps to about 300 cps at 25° C.

3. The use of a dextrin-derived dietary fiber of claim 1, wherein the syrup comprises at least 70% dextrin-derived dietary fiber.

4. The use of a dextrin-derived dietary fiber of claim 1, wherein the syrup further comprises one or more of the group consisting of a flavorant, a colorant, and a sweetener.

5. The use of a dextrin-derived dietary fiber of claim 4, wherein the syrup further comprises a non-caloric sweetener.

6. The use of a dextrin-derived dietary fiber of claim 5, wherein the food is a hard candy that is non-cariogenic.

7. The use of a dextrin-derived dietary fiber of claim 4, further comprising a pharmaceutically-active ingredient.

8. A composition for the enhancement of food materials produced by hydrating an indigestible, low viscosity dietary fiber under condition of sustained high shear during the dispersion and heating, yielding a clear syrup with a viscosity (at 25° C.) of about 35-300 cps, wherein the composition includes at least about 60% of the dextrin.

9. The composition of claim 8, wherein the indigestible, low viscosity dietary fiber component is present in the composition up to about 96% by weight of the final composition.

10. A method for increasing the mellowness of a flavor, texture or processability of foods and beverages, comprising the steps of incorporating composition of claim 8 in said foods and beverages.

11. The method of claim 10, wherein the indigestible, low viscosity non-digestible dietary fiber comprises a dextrin-derived material.

12. A table syrup comprising the composition of claim 8, further comprising at least one of a sweetener, a colorant, and a flavorant.

13. The table syrup of claim 12, further comprising a flavorant that is maple syrup flavoring.

14. The table syrup of claim 13, further comprising one or more carbohydrates selected from the group consisting of sucrose, fructose, palatinit, maltose, isomaltulose, erythritol, inulin, isomalt, tagatose, ribose, and levulose.

15. A hard candy comprising the composition of claim 8, further comprising at least one of a sweetener, a colorant, and a flavorant.

16. The use of the composition of claim 8 as a candy doctor, protecting hard candy against ‘sanding’ (crystallization).

17. The use of the composition of claim 8 in formulating a confectionary glaze.

18. The use of the composition of claim 8 in formulating baked goods.

19. The use of the composition of claim 8 in formulating coatings for fresh or dried fruits.

20. The use of the composition of claim 8 in formulating as a syrup food additive.
